(19) United States
(12) Patent Application Publication
(10) Pub. No.: US 2023/0382310 A1
(43) Pub. Date: Nov. 30, 2023

(54) VEHICLE SLIP-ON PLATFORM

(71) Applicant: Geoffrey Alfred Wilson, Lakeview, OR (US)

(72) Inventor: Geoffrey Alfred Wilson, Lakeview, OR (US)

(21) Appl. No.: 18/202,056

(22) Filed: May 25, 2023

Related U.S. Application Data
(60) Provisional application No. 63/346,999, filed on May 30, 2022.

(51) Int. Cl. B60R 9/06

(52) U.S. Cl. CPC B60R 9/06

(57) ABSTRACT

A system including a vehicle cargo platform and a set of mounting brackets to mount the vehicle cargo platform in a bed of a vehicle (e.g., a truck, ATV, UTV, etc.). The system includes one or more portions configured to receive and secure one or more cargo items (e.g., one or more sub-systems, equipment, tools, bags, containers, etc.) within and to the vehicle cargo platform. The vehicle platform system includes a set of mounting brackets used to securely couple the vehicle cargo platform to portions of a frame of the vehicle.

### CROSS-REFERENCE TO RELATED APPLICATION

This application claims the benefit of U.S. Provisional Application No. 63/346,999, titled “Vehicle Slip-on Incorporating Liquid Delivery System and Equipment Tie-down Platform”, filed May 30, 2022, the entire disclosure of which is incorporated herein by reference.

### TECHNICAL FIELD

Embodiments of the disclosure relate generally to vehicle cargo bed slip-on structures, and more specifically, relate to a multi-purpose platform configured to securely mount within a cargo bed of a vehicle for engage one or more objects relating to various activities (e.g., wildland firefighting, logging operations, outdoor recreation, mining, ranching, and agricultural activities).

### BACKGROUND

In various circumstances and applications, it is desirable to safely secure and transport cargo (i.e., any type of payload including equipment, systems, tools, etc.) using a vehicle (e.g., a truck, utility-terrain vehicles (UTVs), all-terrain vehicles (ATVs), etc. For example, various groups and agencies (e.g., fire departments, agriculture and wildland fire agencies, law enforcement, wildlife protection agencies, etc.) have a need to safely and securely transport critical cargo in a bed or cargo area of a vehicle.

Some approaches to transporting cargo include the use of a slip-on, insert, or skid designed to fit in the bed of a vehicle. Several of these conventional slip-on units have configurations and designs that are limited to particular applications. Accordingly, such slip-on units may be used for specific applications by a particular group (e.g., farmers, ranchers, fire crews, etc.) to transport only a specific piece of equipment or system (e.g., a water tank-pump-discharge configuration) to serve a limited and specific function (e.g., delivering water, herbicides, or other chemical applications.

Another category of slip-on units includes a configuration specially designed for first responder and patient transport. These unit configurations are heavy, with large volume discharge water pumps and not well suited for wildland fire operations. However, application-specific slip-ons that are designed to fit particular vehicle configurations fail to provide several groups with an effective solution.

Furthermore, several conventional solutions that are rigidly designed to enable the transporting of specific equipment fail to account for other cargo transportation needs. For example, existing slip-on units that are designed to transport a water system, fail to provide for the secure transporting of other items. As such, it is common to see firefighter backpacks, food, drinking water, hand tools, fuel cans, drip-torches, and chainsaws floating, bouncing freely in the back of a UTV or truck bed in such instances.

In addition, many conventional UTV fire suppression slip-on units are heavy, weighing approximately 270 pounds or more, when empty. Accordingly, these heavy slip-ons are not suitable for use in mountainous environments requiring wildland fire suppression. The significant weight prevents the vehicle from safely operating in mountain dozer-line conditions, resulting in many fire managers and supervisors electing to keep the cargo bed space empty, with no platform.

In other examples, Federal and State agency wildland fire programs have used Fire/EMS slip-on configurations due to a lack of options. However, these configurations typically have an overly fancy diamond plated, limited utility, high waterflow gasoline engine pumps that are top-heavy, expensive, and lead to disappointing results. In such cases, firefighters are forced to use equipment that is not suitable for the desired task. For example, firefighters may be forced to use gasoline engine pumps—which are loud, dirty, and prone to flooding. These conventional slip-ons configured for gasoline or diesel engines for water delivery do not efficiently serve several applications, and fail to provide a proper platform to securely stow and transport equipment in a vehicle bed.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1 illustrates an example vehicle cargo platform, in accordance with one or more embodiments of the present disclosure.

FIG. 2 shows a top perspective view of an example vehicle cargo platform, in accordance with one or more embodiments of the present disclosure.

FIG. 3 illustrates an example frame portion of a vehicle cargo platform including example cargo engagement components, in accordance with one or more embodiments of the present disclosure.

FIG. 4A illustrates example mounting brackets configured to couple a vehicle cargo platform to portions of a vehicle frame, in accordance with one or more embodiments of the present disclosure.

FIG. 4B shows a top perspective view of an example rear mounting bracket, in accordance with one or more embodiments of the present disclosure.

FIG. 5 illustrates an example frame portion of a vehicle cargo platform coupled to a front mounting bracket having a set of coupling components configured to couple with a portion of a vehicle frame, in accordance with one or more embodiments of the present disclosure.

FIG. 6 illustrates an example frame portion of a vehicle cargo platform coupled to a rear mounting bracket having a set of coupling components configured to couple with a portion of a vehicle frame, in accordance with one or more embodiments of the present disclosure.

FIG. 7 shows a top perspective view of a rear mounting bracket coupled to a first portion of a vehicle frame and a front mounting bracket coupled to a second portion of the vehicle frame, in accordance with one or more embodiments of the present disclosure.

FIG. 8 illustrates a vehicle cargo platform coupled within a vehicle bed using a set of mounting brackets, in accordance with one or more embodiments of the present disclosure.

FIG. 9 illustrates an example water delivery sub-system configured to securely engage within a vehicle cargo platform, in accordance with one or more embodiments of the present disclosure.

FIG. 10 illustrates an example cradle arranged within a vehicle cargo platform, in accordance with one or more embodiments of the present disclosure.

FIG. 11 illustrates an example cradle housing a cargo item arranged within a vehicle cargo platform, in accordance with one or more embodiments of the present disclosure.

### DETAILED DESCRIPTION

The present disclosure relates to a system including a vehicle cargo platform and a set of mounting brackets to mount the vehicle cargo platform in a bed of a vehicle (e.g., a truck, ATV, UTV, etc.). The system (also referred to herein as the “vehicle platform system”) includes one or more portions configured to receive and secure one or more cargo items (e.g., one or more sub-systems, equipment, tools, bags, containers, etc.) within and to the vehicle cargo platform. According to embodiments, the vehicle platform system includes a set of mounting brackets used to securely couple the vehicle cargo platform to portions of a frame of the vehicle.

According to embodiments, the set of mounting brackets can include a first pair of mounting brackets to couple front portions of the vehicle cargo platform to portions of a front of the vehicle. The set of mounting brackets can include a first pair of mounting brackets to couple front portions of the vehicle cargo platform to portions of a front of the vehicle. As used herein, the “front” of the vehicle refers to a first end of a bed of the vehicle that is at a front of the vehicle (i.e., the vehicle cabin-side). As used herein, the “rear” of the vehicle refers to a second end of the bed of the vehicle that is at a back of the vehicle (i.e., the vehicle's tailgate).

According to embodiments, each mounting bracket includes a first set of coupling points configured to align with and enable coupling to corresponding coupling points of the vehicle cargo platform. In an embodiment, each coupling point includes coupling components (e.g., a hole and corresponding coupler, such as a screw, a nut, a bolt, a pin, etc.) that enables a portion of the mounting bracket to securely fasten to a portion of the vehicle cargo platform.

According to embodiments, each mounting bracket includes a second set of coupling points configured to align with and enable coupling to corresponding coupling points of a vehicle frame. Accordingly, the mounting brackets and associated coupling points are used to securely couple the vehicle cargo platform to the vehicle. In an embodiment, the vehicle cargo platform is securely fastened to the frame of the vehicle using the engagement with the mounting brackets. In an embodiment, the vehicle cargo platform is secured to the vehicle by way of a first engagement between the vehicle cargo platform and the first set of coupling points of the mounting bracket via and a second engagement between the vehicle frame via the second set of coupling points of the mounting bracket.

According to embodiments, the vehicle cargo platform can include multiple coupling components arranged at various portions of a base or floor of the vehicle cargo platform. The coupling components can include any suitable coupling mechanism, including D-rings, clips, straps, links, connectors, brackets, hooks, etc. Advantageously, the coupling components can be arranged on the vehicle cargo platform to enable the coupling or attachment of various cargo items to the vehicle cargo platform. According to embodiments, the vehicle cargo platform can include one or more areas that are configured to receive and securely engage one or more sub-systems (e.g., a water delivery sub-system, a container sub-system, etc.).

According to embodiments, the vehicle platform system is configured as a slip-on for secure engagement within a bed of a vehicle. The vehicle platform system employs the coupling components to enable a latch and tie-down strap system which allows for a multitude of configurations to securely store various cargo items (e.g., five-gallon fuel cans, drip-torches, chainsaws, hose, external pumps, crew gear bags, coolers, food, drinking water, tools, etc.). The coupling components provide a sub-system to address and overcome issues associated with storing equipment securely while the vehicle traverses over uneven terrain.

According to embodiments, the vehicle cargo platform includes coupling components (e.g., D-rings) that are welded at various position throughout the platform, allowing various kinds of loads to be tied-down snugly at multiple points and angles. In an embodiment, the base or floor of the vehicle cargo platform includes a corrugated rubber matting to reduce the vibration and friction that can cause damage to the cargo.

According to embodiments, the set of mounting brackets enable the vehicle cargo platform to be securely attached to a vehicle's cargo bed rail anchor holes, meaning the whole platform is securely bonded to the vehicle. The mounting brackets are configured to facilitate easy and efficient installation. In an embodiment, the mounting brackets can be installed to secure the vehicle cargo platform to the vehicle without the use of a tool and avoids the need to drill directly into the cargo bed flooring of the vehicle.

According to embodiments, the mounting brackets are configured to align and correspond with pre-existing coupling points integrated within the frame of the vehicle (e.g., pre-existing tie-down anchor holes). This enables the mounting brackets to couple with the vehicle using existing coupling points of the vehicle, without the need to drill into the bed floor of said vehicle, creating an extremely secure bond between the vehicle and the vehicle cargo platform.

According to embodiments, the vehicle cargo platform can be composed of welded metal, high density plastic, or a combination thereof. The vehicle cargo platform and mounting brackets are constructed to withstand gravitational forces and violent jarring associated with traversing rough terrain (e.g., side slopes, dozer-lines, remote wilderness areas without roads, mountains, mines, wooded areas, etc.).

In an embodiment, the vehicle cargo platform includes a frame housing or tank cradle to secure a tank in place. The tank cradle and coupling components of the vehicle cargo platform can be used to secure a liquid holding tank within the vehicle cargo platform, dispersing the gravitational effects of liquid sloshing away from the holding tank(s) walls and joints and into the metal frame of the vehicle cargo platform. In an embodiment, the frame housing or tank cradle allows for a tank sub-system to employ a thinner tank-wall design, which reduces the overall weight of the tank sub-system.

According to embodiments, the vehicle platform system can include a cradle or housing to securely hold one or more structures or sub-systems (e.g., a water delivery sub-system or tank sub-system). For example, the cradle housing can accommodate a tank cradle holding structure with a removable electronic liquid delivery system mounted on top of the tank cradle.

According to embodiments, the cradle protects electric liquid pump and includes a plastic housing that can incorporate an electronic control panel including on-off power switches. In embodiments, the cradle can include high visibility lighting, and controls for pump or pumps power with a liquid level gauge or gauges attached to the electric control panel via wiring to a liquid tank or tanks. In an embodiment, one or more liquid tanks can fit inside the cradle and can be removed from the cradle once a liquid delivery sub-system top is removed. In an embodiment, the cradle can receive and secure a liquid delivery sub-system having a liquid depth sensor mounted to the one or more liquid tanks with wiring connected to a control panel. In an embodiment, the cradle can receive and house a liquid delivery sub-system include a hose-reel attached to the tank cradle top connected to a pump outlet via plumping.

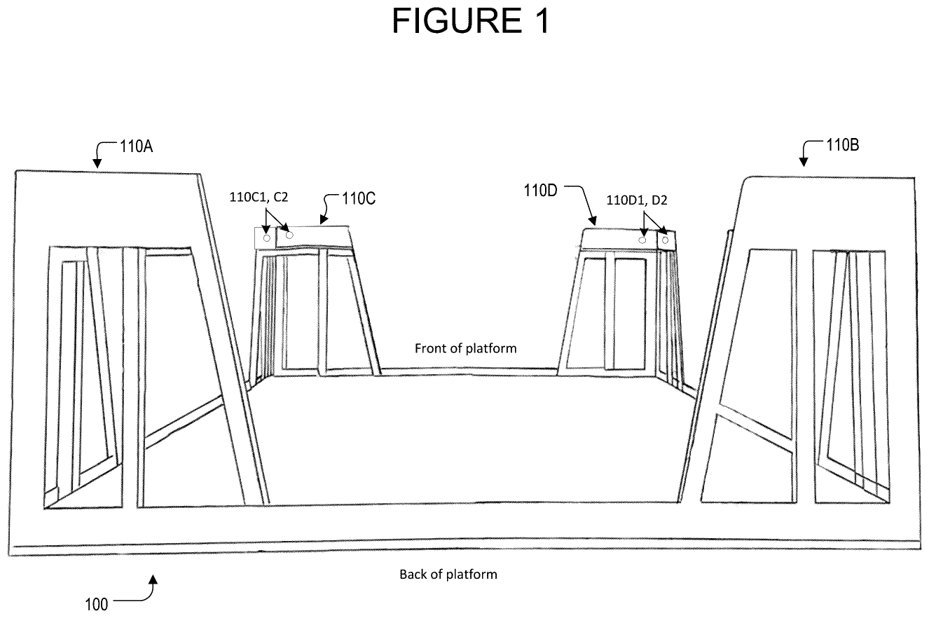

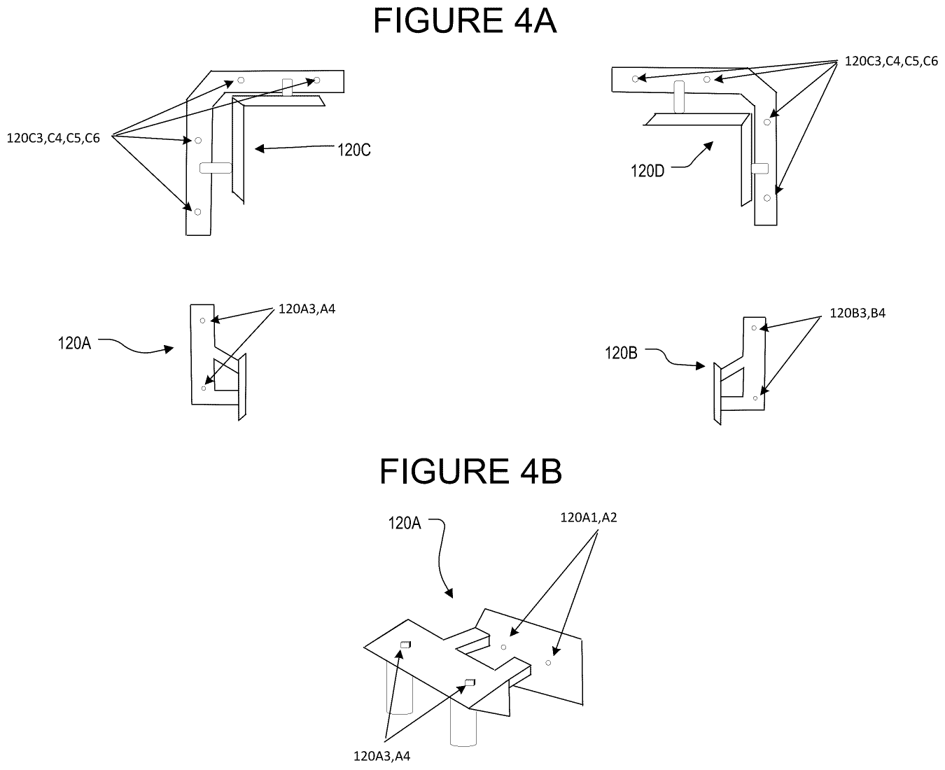

FIG. 1 illustrates an example vehicle cargo platform 100, according to one or more embodiments. The vehicle cargo platform 100 is configured to be securely mounted within a cargo bed of a vehicle. As shown in FIG. 1, the vehicle cargo platform 100 includes a set of platform frames 110A, 110B, 110C, and 110D. Platform frames 110A and 110B are arranged at a back portion of the vehicle cargo platform 100 (i.e., a first end of the platform that is arranged at the back of a cargo bed of a vehicle). The vehicle cargo platform 100 further includes platform frames 110C and 110D arranged at a front portion of the vehicle cargo platform 100 (i.e., a second end of the platform 100 that is arranged at a front of the cargo bed of the vehicle). As illustrated in FIG. 1, platform frame 110C includes a set of coupling points 110C1, 110C2 configured to securely engage with a corresponding mounting bracket (shown in FIGS. 4A, 4B, 5, 6, 7 and 8) of the vehicle platform system. FIG. 1 further illustrates platform frame 110D including a set of coupling points 110D1, 110D2 configured to securely engage with a corresponding mounting bracket of the vehicle platform.

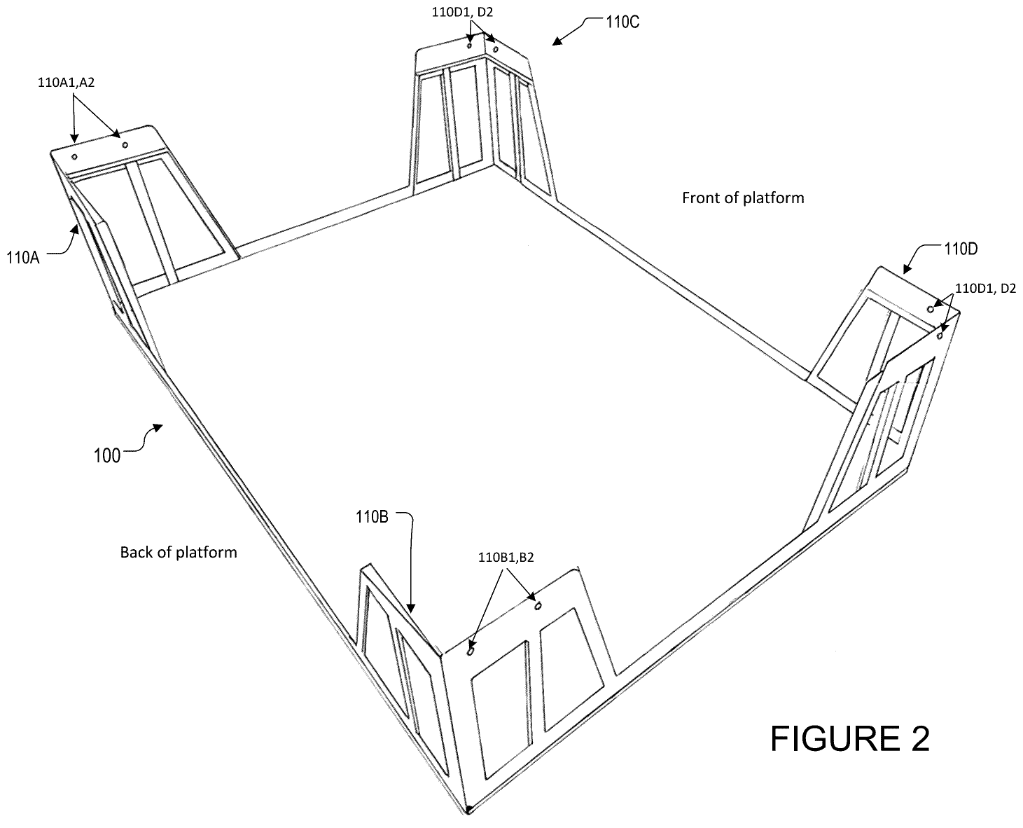

FIG. 2 shows a top perspective view of an example vehicle cargo platform 100, in accordance with one or more embodiments of the present disclosure. As illustrated, the vehicle cargo platform 100 includes frames 110A, 110B, 110C, and 110D. Each of the frames 110A-D includes coupling points (e.g., coupling points 110A1, A2 of frame 110A, coupling points 110B1, B2 of frame 110B, coupling points 110C1, C2 of frame 110C, and coupling points 110D1, D2 of frame 110D) configured to engage or couple with a respective mounting brackets (not shown in FIG. 2).

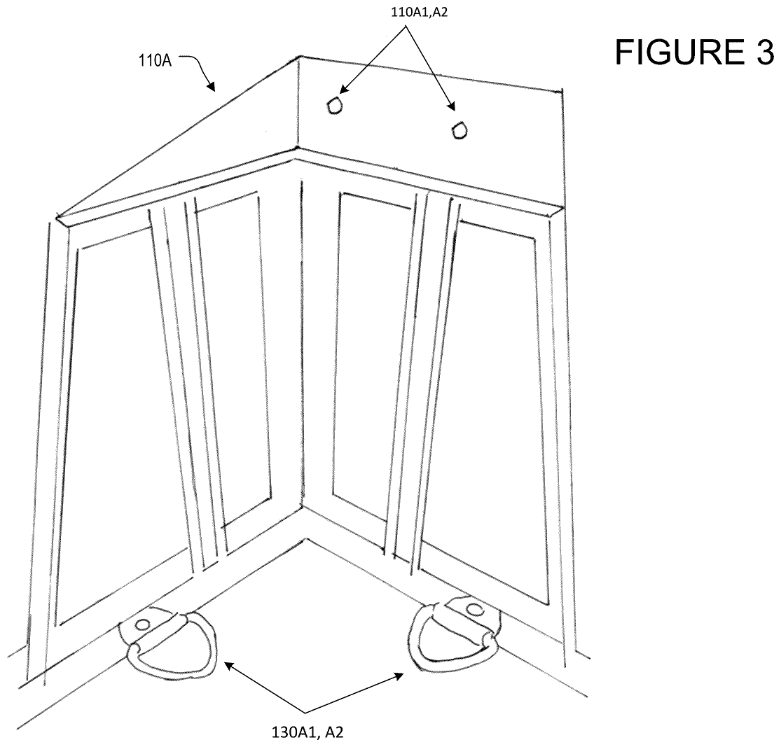

FIG. 3 illustrates an example frame portion 110A of a vehicle cargo platform (e.g., vehicle cargo platform 100 of FIGS. 1 and 2) including example cargo engagement components 130A1 and 130A2, in accordance with one or more embodiments of the present disclosure. As illustrates, the cargo engagement components 130A1 and 130A2 are structurally coupled to or integrated with a portion of the frame 110A to provide for a mechanism to attach, couple, engage, etc. one or more cargo items. In the example shown, the cargo engagement components 130A1 and 130A2 are D-rings that allow various kinds of cargo items (e.g., loads) to be secured to the vehicle cargo platform at multiple points and angles. According to embodiment, the cargo engagement components 130A1 and 130A2 (e.g., D-rings) can be located at multiple different points of a base or floor surface of the vehicle cargo platform.

As described herein, the vehicle cargo platform 100 can be mounted and secured to a vehicle using a set of mounting brackets. FIG. 4A illustrates a top view of example mounting brackets 120A, 120B, 120C, and 120D. According to embodiments, mounting bracket 120A is configured to couple with frame 110A, mounting bracket 120B is configured to couple with frame 110B, mounting bracket 120C is configured to couple with frame 110C, and mounting bracket 120D is configured to couple with frame 120D.

According to embodiments, the mounting brackets 120A-120D include a set of coupling points (e.g., coupling points 120C3, C4, C5, and C6 of mounting bracket 120C) that are positioned and configured to enable coupling of the mounting bracket 120 and a portion of a vehicle (e.g., a portion of a frame of the cargo bed of the vehicle. As shown, a first front mounting bracket 120C includes coupling points 120C3, C4, C5, and C6 for coupling with a first portion of the vehicle and a second front mounting bracket 120D includes coupling points 120D3, D4, D5, and D6 for coupling with a second portion of the vehicle.

According to embodiments, a first rear mounting bracket 120A includes coupling points 120A3 and 120A4 for coupling with a third portion of the vehicle and a second rear mounting bracket 120B includes coupling points 120B3 and 120B4 for coupling with a fourth portion of the vehicle.

FIG. 4B shows a top perspective view of an example rear mounting bracket 120, in accordance with one or more embodiments of the present disclosure. As shown, the rear mounting bracket 120 includes a first set of coupling points 120A1 and 120A2 for engagement with the vehicle cargo platform and a second set of coupling points 120A3 and 120A4 for engagement with a vehicle. Accordingly, each mounting bracket (120A-D) and corresponding coupling points enables the vehicle cargo platform 100 to be securely engage with the vehicle.

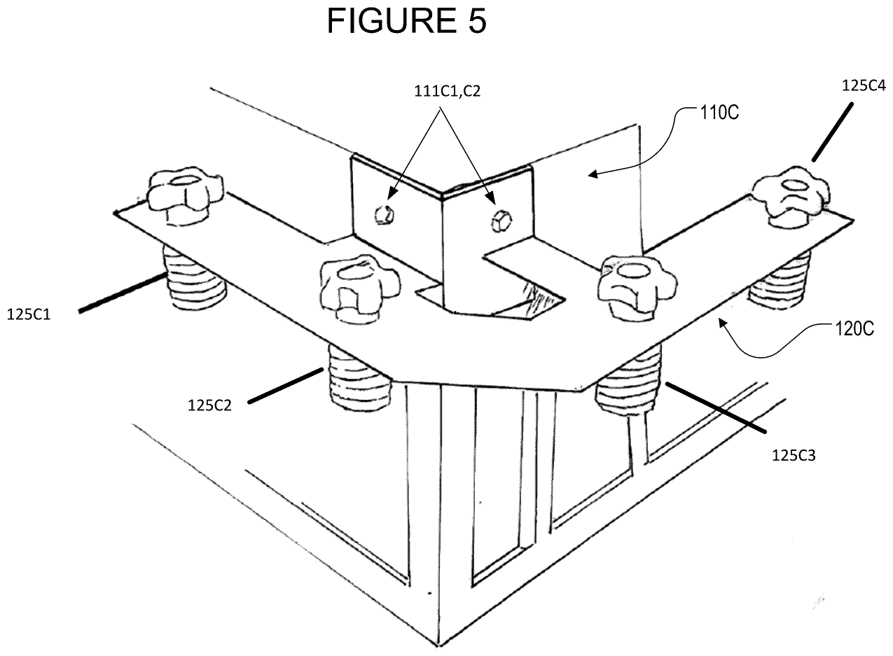

FIG. 5 illustrates an example frame portion of a vehicle cargo platform 100C coupled to a front mounting bracket 120C having a set of coupling components 125C1, 125C2, 125C3, and 125C4 configured to couple with a portion of a vehicle frame (not shown), in accordance with one or more embodiments of the present disclosure. Each coupling components (125C1-C4) can include any suitable structure configured to securely engage within a corresponding portion (e.g., a bore or hole) of a vehicle. In an embodiment, the coupling components 125C1-C4 can be threaded screws that are introduced into threaded engagement with corresponding bores of the vehicle frame. In an embodiment, the coupling components 125C1-C4 can include rubber and/or hardware anchor hole inserts configured to attach the mounting bracket 120C to a cargo bed rail or rail bracket having cargo bed rail anchor holes, where the anchor hole inserts then are twisted to expand rubber creating an extremely tight hold, mounting the mounting bracket and vehicle cargo platform securely to the cargo bed rail of the vehicle.

In an embodiment, each corner of the vehicle cargo platform 100C includes a strut-and-tie structural arm configuration that attaches to each mounting bracket (e.g., mounting bracket 120C) via a coupling component 111C1, C2 (e.g., nuts and bolts), where the mounting bracket 120C in turn attaches or bonds the vehicle cargo platform 100 to the vehicle via strut-and-tie arm to resist compression and tension and creating an extremely secure engagement.

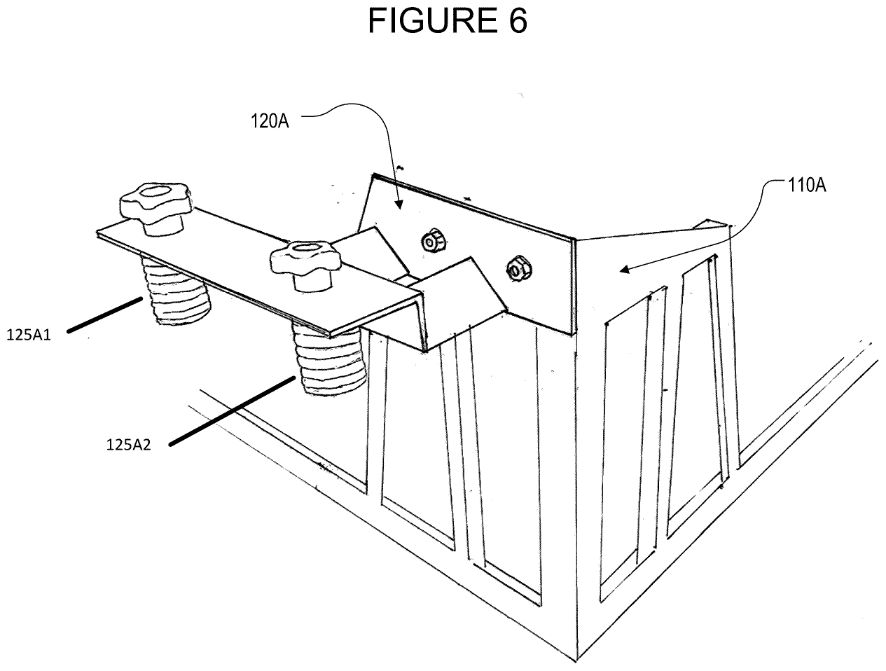

FIG. 6 illustrates an example frame portion 110A of a vehicle cargo platform 100 coupled to a rear mounting bracket 120A having a set of coupling components 125A1, A2 configured to couple with a portion of a vehicle frame (not shown), in accordance with one or more embodiments of the present disclosure. Similar to the front mounting bracket 110C of FIG. 5, the coupling components 125A1, A2 can include any suitable fastening structure configured to engagement with a corresponding rail or frame portion of a vehicle.

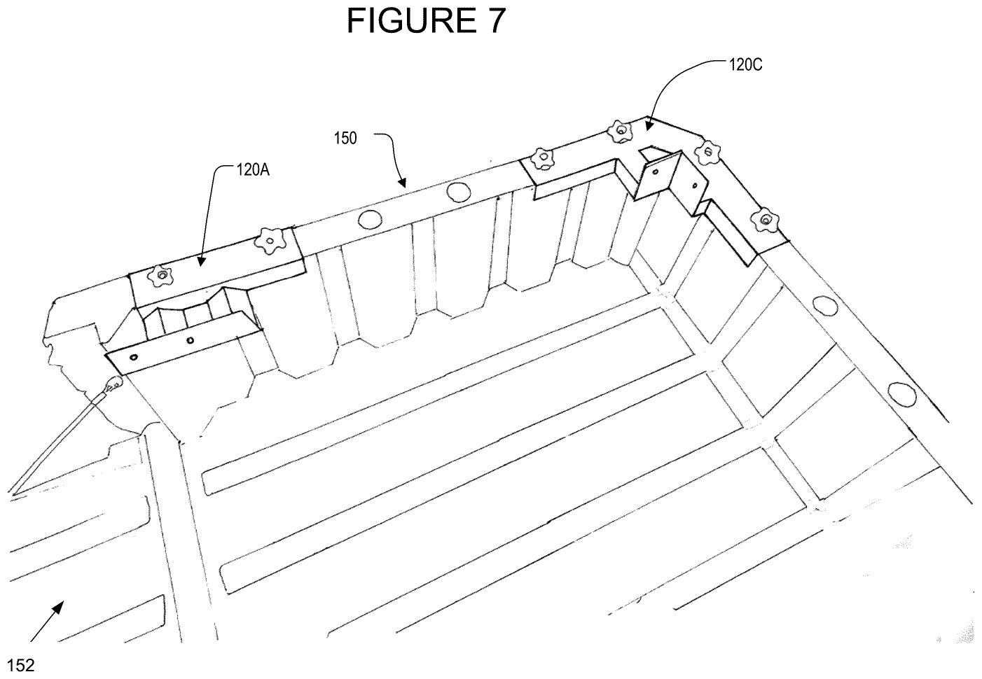

FIG. 7 shows a top perspective view of a rear mounting bracket 120A coupled to a first portion of a vehicle frame 150 and a front mounting bracket 120C coupled to a second portion of the vehicle frame 150, in accordance with one or more embodiments of the present disclosure. As shown, one side of the vehicle frame 150 (i.e., the driver's side) is arranged with the mounting brackets (i.e., the rear mounting bracket 120A located at a tailgate 152 end of the vehicle bed and the front mounting bracket 120C located at a front-end of the vehicle bed). According to embodiments, a pair of mounting brackets (e.g., 120B and 120D) are engaged on the other side of the vehicle frame (i.e., the passenger's side), as described in detail above. Accordingly, mounting brackets are mounted on each of the four corners of the frame surrounding the vehicle bed. Each of the mounting brackets are then attached to corresponding portions of the frame of the vehicle cargo platform 100 to secure the vehicle cargo platform within the vehicle bed.

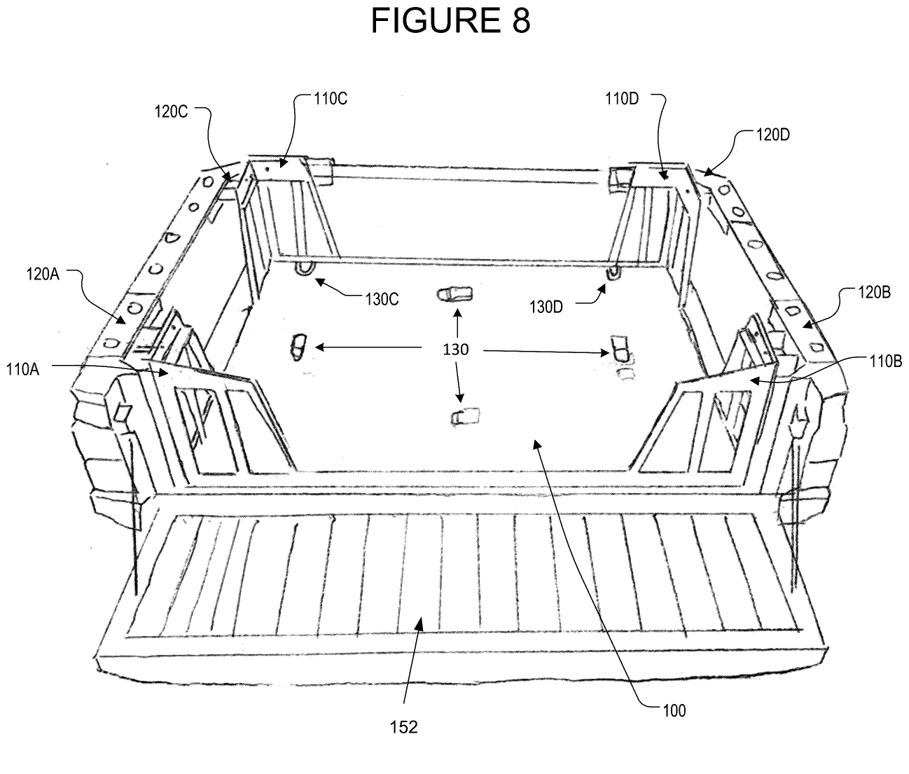

FIG. 8 illustrates a vehicle cargo platform coupled within a vehicle bed using a set of mounting brackets, in accordance with one or more embodiments of the present disclosure. As illustrated, the vehicle cargo platform 152 is secured within a vehicle bed using mounting brackets 110A, 110B, 110C, and 110D. The vehicle cargo platform 152 is securely engaged within the vehicle bed by coupling the respective frames 110A-110D of the platform 152 to portions of the vehicle bed frame using respective mountings brackets 120A-120D. Advantageously, in an embodiment shown in FIG. 8, the vehicle cargo platform includes a series of cargo engagement components (130, 130C, 130D) configured to securely couple one or more cargo items within and to the vehicle cargo platform 152.

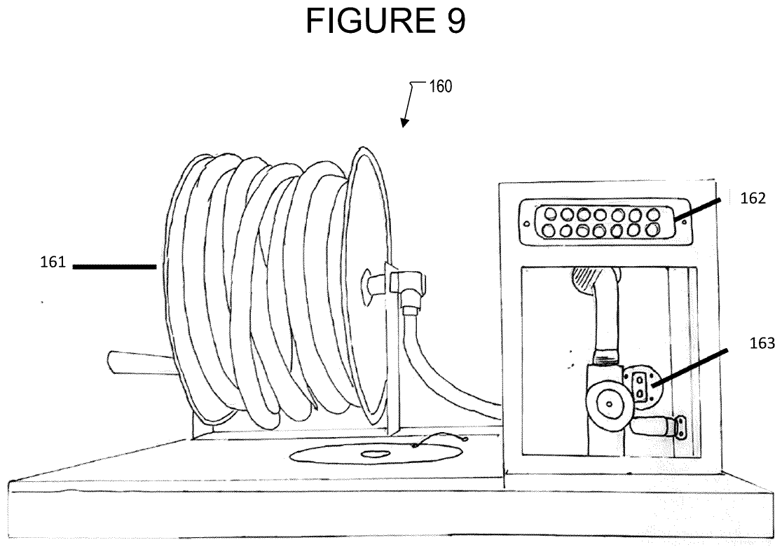

FIG. 9 illustrates an example water delivery sub-system 160 configured to securely engage within a vehicle cargo platform 100, in accordance with one or more embodiments of the present disclosure. According to embodiments, the water delivery sub-system 160 includes a hose reel 161, an array of LED lighting 162, and a quick connect power inlet 163. The water delivery sub-system 160 can include various other elements and components, including, for example, a control panel, water level gauge, removable pump cover, water tank fill port access cover, spring latch, removable rear cover, etc.

According to embodiments, the base or floor of the vehicle cargo platform 100 can include one or more configuration having sections, areas or portions adapted to receive and securely store various components, including but not limited to, the water delivery sub-system 160, five-gallon fuel cans, drip-torches, chainsaws, hose, external pumps, crew gear bags, coolers, food, drinking water and the tools fire crews work with every day. The strap tie-down system addresses storing equipment handling securely while transporting over uneven terrain. For example, welded D-rings can be arranged and positioned throughout the platform, allowing various kinds of loads to be tied-down snugly at multiple points and angles.

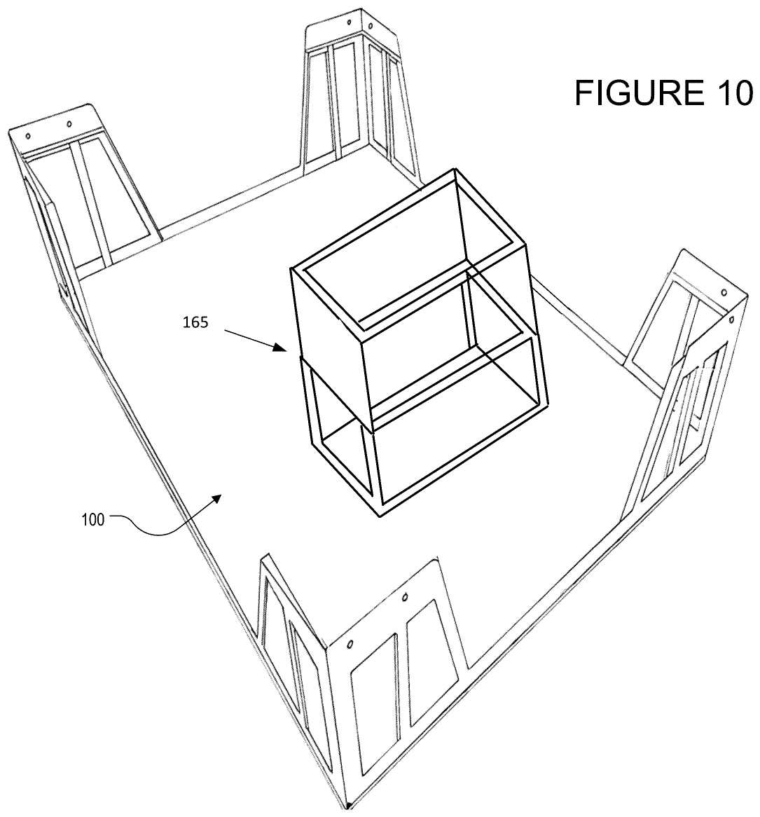

FIG. 10 illustrates an example cradle 165 arranged within a vehicle cargo platform 100. According to embodiments, the cradle 165 may be integrally coupled to a base or floor of the vehicle cargo platform 100. In an embodiment, the cradle 165 may be coupled to a base or floor of the vehicle cargo platform 100 using one or more mounting or attachment components (e.g., a set of bolts, screws, fasteners, etc.), guides, rails, etc. In an embodiment, the cradle 165 is sized and dimensioned to securely house one or more cargo items. Example cargo items include a tank, a water delivery system, etc.

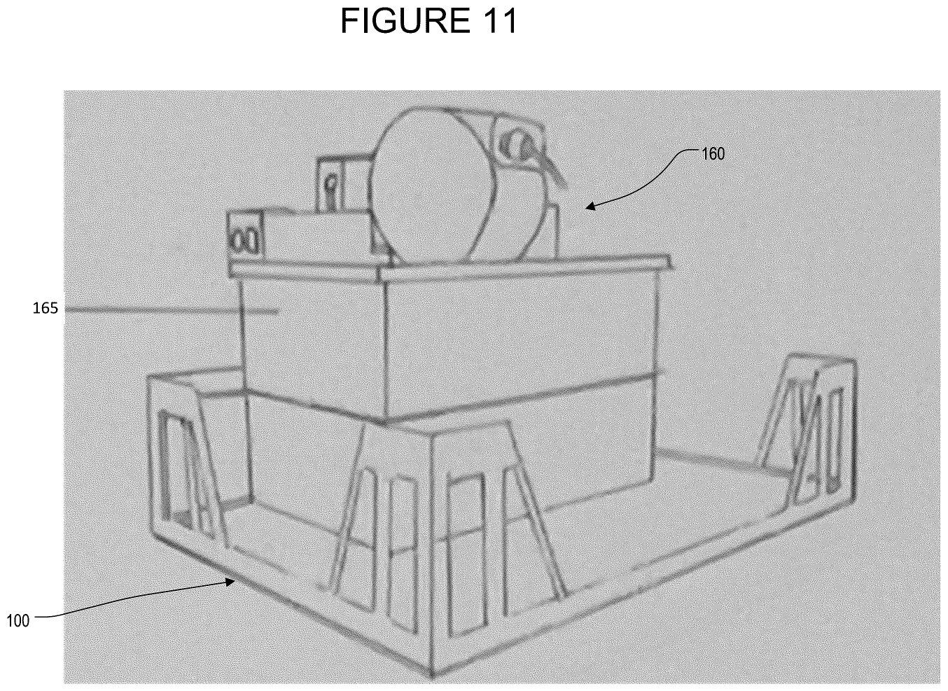

FIG. 11 illustrates an example cradle 165 arranged within the vehicle cargo platform 100. The cradle 165 is configured to hold one or more tanks, a water delivery sub-system 160, or other cargo item(s) in place. In an embodiment, the cradle 165 is structurally integrated with or attached to the vehicle cargo platform 100. In an embodiment, the cradle 165 is configured to receive and secure one or more liquid holding tanks, dispersing the gravitational effects of liquid sloshing away from the holding tank(s) walls and joints and into the metal frame of the vehicle cargo platform 100.

In an embodiment, the cradle 165 is configured to secure liquid holding tank(s) designed to maintain a center of gravity of the vehicle low and central. The tanks may be equipped with a slow flow chamber baffle system to reduce the effects of sloshing liquid during side-slope operations in mountainous terrain, which results in a desired weight distribution. The cradle 165 can be configured to accept and secure tanks having varying sizes (e.g., 25 liquid gallon capacity, a 45 liquid gallon capacity, a 65 liquid gallon capacity, etc.). According to embodiments, the tank can include various components, including but not limited to an intake in-line filter, a water tank fill access cover, a water float sensor, a tank suction hose, a bottom strainer, a water tank sensor, etc.

The foregoing disclosure of the exemplary embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

Further, in describing representative embodiments, the specification may have presented aspects of the operation of the exemplary device as a particular sequence of steps. However, to the extent that the methods or processes do not rely on the particular order of steps set forth herein, the methods or processes should not be limited to the particular sequence of steps described. As one of ordinary skill in the art would appreciate, other sequences of steps may be possible. Therefore, the particular order of the steps set forth in the specification should not be construed as limitations on the claims.

While the invention is susceptible to various modifications, and alternative forms, specific examples thereof have been shown in the figures and are herein described in detail. It should be understood, however, that the invention is not to be limited to the particular forms or methods disclosed, but to the contrary, the invention is to cover all modifications, equivalents and alternatives falling within the scope of the appended claims.

What is claimed is:

1. A system comprising:
a vehicle cargo platform comprising:
a first frame and a second frame arranged at a first end of the vehicle cargo platform; and
a third frame and a fourth frame arranged at a second end of the vehicle cargo platform; and
a set of mounting brackets comprising:
a first mounting bracket configured to couple with the first frame of the vehicle cargo platform and a first portion of a vehicle;
a second mounting bracket configured to couple with the second frame of the vehicle cargo platform and a second portion of the vehicle;
a third mounting bracket configured to couple with the third frame of the vehicle cargo platform and a third portion of the vehicle; and
a fourth mounting bracket configured to couple with the fourth frame of the vehicle cargo platform and a fourth portion of the vehicle.

2. The system of claim 1, wherein the first portion and the second portion of the vehicle comprise portions of a frame of the vehicle arranged at a front-side of the vehicle.

3. The system of claim 1, wherein the third portion and the fourth portion of the vehicle comprise portions of a frame of the vehicle arranged at a rear-side of the vehicle.

4. The system of claim 1, wherein the first mounting bracket is coupled to the first frame of the vehicle cargo platform via one or more coupling components.

5. The system of claim 1, wherein the vehicle cargo platform comprises a set of cargo coupling components.

6. The system of claim 5, wherein the set of cargo coupling components are arranged at a plurality of locations on a floor of the vehicle cargo platform.

7. The system of claim 1, wherein the vehicle cargo platform comprises a cradle configured to house one or more tanks.

8. The system of claim 1, wherein the first mounting bracket comprises a first set of coupling points and a second set of coupling points.

9. The system of claim 8, wherein the first set of coupling points corresponds to a third set of coupling points of the first frame of the vehicle cargo platform.

10. The system of claim 9, wherein the second set of coupling points corresponds to a fourth set of coupling points of the first portion of the vehicle.

11. The system of claim 1, wherein the first mounting bracket couples to the first portion of the vehicle via one or more anchor hole inserts.

12. The system of claim 11, wherein the one or more anchor hole inserts are configured to be twisted to expand within one or more corresponding bores of a frame of a cargo bed of the vehicle.

13. The system of claim 1, wherein the first mounting bracket couples to the first frame of the vehicle cargo platform via one or more coupling components.

14. The system of claim 1, wherein the vehicle cargo platform comprises a floor having a corrugated rubber surface.

15. The system of claim 1, wherein the vehicle cargo platform comprises a cradle configured to receive and engage a water delivery sub-system.
